(19) United States
(12) Patent Application Publication
(10) Pub. No.: US 2010/0315073 A1
(43) Pub. Date: Dec. 16, 2010

(54) MAGNETIC ENCODER APPARATUS AND MANUFACTURING METHOD THEREFOR

(75) Inventors: Yuji Arinaga, Kitakyushu-shi (JP); Katsuya Okumura, Tokyo (JP)

Correspondence Address: SUGHRUE-265550, 2100 PENNSYLVANIA AVE. NW, WASHINGTON, DC, 20037-3213, US

(73) Assignee: Kabushiki Kaisha Yaskawa Denki, Kitayushu-shi (JP)

(21) Appl. No.: 12/445,695

(22) PCT Filed: Oct. 4, 2007
(86) PCT No.: PCT/JP2007/069430

§ 371 Date: Apr. 15, 2009

(30) Foreign Application Priority Data
Oct. 16, 2006 (JP) 2006-281437

(51) Int. Cl. G01B 7/30

(52) U.S. Cl. 324/207.25

(57) ABSTRACT

Provided are a magnetic encoder apparatus, which can accurately perform angle detection, wherein at very accurate positions, magnetic field detection elements are mounted on a fixed member, and wherein the positions of the magnetic field detection elements are little changed due to temperature, and a method for manufacturing the magnetic encoder apparatus.

Conductive pads (32) are formed, using an insulating material as a base, on the four side faces of a fixed member (3) having a shape that is substantially a right square prism. Magnetic field detection elements (4) are mounted on these pads (32). A cylindrical space (28) is formed in the center of the fixed member (3), and when a permanent magnet (2) fixed to a rotary member (1) is rotated in the space (28), the magnetic field detection elements (4) output signals, with a small phase error between them. A signal processing circuit (not shown) converts these output signals into angular signals.

### TECHNICAL FIELD

The present invention relates to a magnetic encoder apparatus for detecting the rotational position of a rotary member, and relates particularly to a magnetic encoder apparatus, wherein magnetic field detection elements are precisely positioned, and to a manufacturing method therefor.

### RELATED ART

A magnetic encoder apparatus, wherein magnetic field detection elements detect the magnetic field of a permanent magnet, which is fixed to a rotary member and is magnetized in one direction perpendicular to the rotation axis of the rotary member, to measure the angle of a rotation of the rotary member, and wherein the field detection elements are provided for a flexible printed circuit that is secured to a fixed member, has been conventionally disclosed (see, for example, patent document 1).

FIG. 10 is a structural diagram for a conventional magnetic encoder apparatus.

In this drawing, reference numeral 1 denotes a rotary member, and reference numeral 2 denotes a disk-shaped permanent magnet that is fixed to the rotary member 1 and is magnetized in parallel to one direction perpendicular to the axis of the rotary member. Reference numeral 3 denotes a ring-shaped fixed member positioned around the outside of the permanent magnet 2 by an intervening gap, and reference numeral 4 denotes a pair of magnetic field detection elements for which the phases have been shifted at a mechanical angle of 90° from each other, and which are positioned by shifting their phases until one pair of two field detection elements are shifted at 180 degrees from each other. Reference numeral 51 denotes a frame provided around the outside of the fixed member 3. Reference numeral 9 denotes a flexible printed circuit that is adhered to the inner face of the fixed member 3, and that includes a fixing portion 91, secured to the fixed member 3 at four circumferential locations spaced at equal intervals, a circular center portion 92, and a coupling portion 93 that connects the fixed portion 91 to the center portion 92.

FIG. 11 is a front developed view of the flexible printed circuit 9.

As shown in this drawing, a narrow portion 94 having low rigidity is formed at a join of the coupling portion 93 and the fixing portion 91 so the structure can be easily bent. A plurality of terminals 97 and 98 are respectively arranged on the fixing portion 91 and the center portion 92, and corresponding terminals 97 and 98 are connected by conductive portions 96. The magnetic field detection elements 4 are attached to the surfaces of the terminals 97.

In FIG. 10, reference numeral 70 denotes a printed circuit that is fixed to the inside of the frame 51. The flexible printed circuit 9 is laminated on the printed circuit 70, and the terminals 98 in the center of the flexible printed circuit 9 are employed to establish electrical connections with the printed circuit 70. Signals from the magnetic field detection elements 4 are transmitted via the terminals 97, the conductive portions 96 and the terminals 98 to the printed circuit 70. Reference numeral 80 denotes a signal processing circuit mounted on the printed circuit 70 to process a signal detected by the magnetic field detection element 4, and to calculate and output the absolute value of the position of the rotary member 1.

Patent Document 1: JP-A-11-237257

### DISCLOSURE OF THE INVENTION

### Problems to be Solved by the Invention

For a conventional magnetic encoder apparatus, magnetic field detection elements are mounted on terminals that are formed on a flexible printed circuit. Since the flexible printed circuit is bent and attached to a fixed member, there is a problem that, due to its resiliency, the flexible printed circuit is shifted from the fixed member and the positioning accuracy of the magnetic field detection elements is deteriorated, and accordingly, a phase error occurs between signals output by the magnetic field detection elements, reducing the angle detection precision of the magnetic encoder. As another problem, since thermal expansion coefficient of the flexible printed circuit is great, a change in the temperature adversely affects the positions of the magnetic field detection elements on the terminal patterns of the flexible circuit, and the phase difference between signals output by the magnetic field detection elements is changed, depending on the temperature, so that the accuracy of the magnetic encoder, relative to the temperature, is deteriorated.

In order to solve these problems, one objective of the present invention is to provide a magnetic encoder apparatus having a high detection angle accuracy, wherein magnetic field detection elements are highly accurately attached to a fixed member and their positioning is less affected by temperature, and a manufacturing method therefor.

### Means for solving the Problems

To resolve the problems, the present invention has the following configuration.

According to the invention of claim 1, there is provided a magnetic encoder apparatus including:

a disk-shaped or ring-shaped permanent magnet that is fixed to a rotary member and is magnetized in a direction perpendicular to an axis of the rotary member;

a fixed member in which a space is formed to arrange the permanent magnet;

a plurality of magnetic field detection elements that are radially arranged opposite the permanent magnet with an intervening gap;

a signal processing circuit that processes signals obtained by the magnetic field detection elements; and

conductive pads for electrical connections to the magnetic field detection elements, being mounted on a side face of an electrical insulating material substrate of the fixed member.

According to the invention of claim 2, there is provided the magnetic encoder apparatus according to claim 1, wherein

the fixed member is formed of ceramics.

According to the invention of claim 3, there is provided the magnetic encoder apparatus according to claim 1, wherein

either a power supply pattern for supplying electric power to the magnetic field detection elements, or the power supply pattern and a signal pattern for connections to output terminals of the magnetic field detection elements, are formed for the fixed member.

According to the invention of claim 4, there is provided the magnetic encoder apparatus according to claim 1, wherein

the fixed member is almost a right square prism in which a cylindrical space is internally formed.

According to the invention of claim 5, there is provided the magnetic encoder apparatus according to claim 1, wherein

the fixed member includes a space having an almost square shape.

According to the invention of claim 6, there is provided the magnetic encoder apparatus according to claim 1, wherein

positioning portions for fixing the magnetic field detection elements are formed on side faces of the fixed member.

According to the invention of claim 7, there is provided the magnetic encoder apparatus according to claim 1, wherein

the positioning portions serve as a reference centerline for positioning the magnetic field detection elements.

According to the invention of claim 8, there is provided the magnetic encoder apparatus according to claim 1, wherein

the magnetic field detection elements are Hall effect sensors including Hall elements in packages.

According to the invention of claim 9, there is provided a method for manufacturing a magnetic encoder apparatus including: a disk-shaped or ring-shaped permanent magnet that is fixed to a rotary member and is magnetized in a direction perpendicular to an axis of the rotary member; a fixed member in which a space is formed to arrange the permanent magnet; four magnetic field detection elements that are radially arranged opposite the permanent magnet with an intervening gap; and a signal processing circuit that processes signals obtained by the magnetic field detection elements,

the method including:

securely attaching the magnetic field detection elements to the fixed member so that chips in packages of the magnetic field detection elements are positioned at 90 degree angles of each other.

According to the invention of claim 10, there is provided the magnetic encoder apparatus manufacturing method according to claim 9, wherein

a centerline for a positioning reference is formed on side faces of the fixed member;

positioning for the chips in the packages is calculated;

positions for mounting the packages on the fixed member are adjusted to align the positions of the chips with the centerline; and

the packages are fixed to the fixed member.

### ADVANTAGE OF THE INVENTION

According to the invention of claim 1, since conductive pads are formed on the side faces of the fixed member, made of an insulating material, and magnetic field detection elements are arranged thereon, positioning of the magnetic field detection elements can be performed accurately. Therefore, phase errors between signals output by the magnetic field detection elements are small, and the rotational angle detection accuracy is increased.

According to the invention of claim 2, when the fixed member is made of ceramics, deformation of the fixed member relative to a temperature change can be substantially ignored. Therefore, phase differences between signals output by the magnetic field detection elements are little changed relative to temperatures, and a magnetic encoder having a superior temperature characteristic can be provided.

According to the invention of claim 3, since a power supply pattern for the magnetic field detection elements, or a power supply pattern and a signal pattern, are formed on the fixed member, the number of wires required for the magnetic field detection elements can be reduced.

According to the invention of claim 4, since the fixed member is almost a right square prism in which a cylindrical space is formed, the magnetic field detection elements need only be arranged on the side faces of the substantially right square prism, so that accurate detection signals having phase differences of 90 degrees of each other can be easily obtained.

According to the invention of claim 5, since an almost regular quadrilateral space is provided in the fixed member, the magnetic field detection elements can be arranged along the side faces of the fixed member where space is present, and an intervening gap can be reduced between the permanent magnet located at the space and the magnetic field detection elements. Therefore, the detection levels of detection signals received from the magnetic field detection elements can be increased, and the noise-resistant magnetic encoder apparatus can be provided.

According to the invention of claim 6 or 7, since the positioning portions for fixing the magnetic field detection elements are formed on the side faces of the fixed member, the magnetic field detection elements can be easily and accurately secured.

According to the invention of claim 8, when Hall effect sensors are employed as the magnetic field detection elements, a small magnetic encoder apparatus can be provided at a low cost.

According to the invention of claim 9, the positions of chips of the magnetic field detection elements are measured using an optical detector, such as an X ray, and when the magnetic field detection elements are securely attached to the fixed member, the chips are located at positions at 90 degrees of each other. Therefore, more accurate positioning can be performed, and accordingly, detection accuracy increased even more.

According to the invention of claim 10, an error is calculated between the chip positions of the magnetic field detection element and the sensor center position defined in the magnetic field detection element packages, and when the magnetic field detection elements are fixed by taking this error into account, misalignment of the chip positions of the magnetic field detection element packages can be corrected, and the detection accuracy is more increased.

### BRIEF DESCRIPTION OF THE DRAWINGS

FIG. 1(a) is a front view of a magnetic encoder apparatus according to a first embodiment of the present invention, and FIG. 1(b) is a cross sectional view taken along line A-A in FIG. 1(a).

FIGS. 2(a) and 2(b) are perspective views of the structure of a fixed member according to the first embodiment of the present invention.

FIG. 3 is a perspective view of a connection state of the fixed member, magnetic field detection elements and a flexible printed circuit according to the first embodiment of the present invention.

FIG. 4 is a diagram showing waveforms output by the magnetic field detection elements in the first embodiment of the present invention.

FIG. 5 is a perspective view of a fixed member according to a second embodiment of the present invention.

FIG. 6 is a graph showing the affect produced by temperature on a phase difference of pseudo-sinusoidal wave output by the magnetic field detection elements in the second embodiment of the present invention.

FIG. 7 is a front view of a fixed member according to a third embodiment of the present invention.

FIG. 8 is a diagram illustrating the position of a chip in a magnetic field detection element according to the third embodiment of the present invention.

FIG. 9 is a partial side view of a fixed member according to a fourth embodiment of the present invention, indicating the position of a magnetic field detection element on the side face of the fixed member.

FIG. 10 is a diagram illustrating the structure of a conventional magnetic encoder apparatus.

FIG. 11 is a front developed view of a flexible printed circuit employed for the conventional magnetic encoder apparatus.

### DESCRIPTION OF REFERENCE NUMERALS AND SIGNS

1: rotary member
2: permanent magnet
28, 29: space
3, 30: fixed member
31: copper pattern
311: power supply pattern
312: signal pattern
32, 33: pad
35: sensor center
36: centerline of a sensor center
37: notch line indicating the center position of a fixed member
38: chip center
4: magnetic field detection element
41: A+ phase magnetic field detection element
42: B+ phase magnetic field detection element
43: A− phase magnetic field detection element
44: B− phase magnetic field detection element
45: magnetic field detection element lead
46: magnetic field detection element chip
47: reference chip position range
48: package
5, 51: frame
6: cover
7: flexible printed circuit
70: printed circuit
71: terminal
72: wiring pattern
80: signal processing circuit
9: flexible printed circuit
91: fixing portion
92: center portion
93: coupling portion
94: narrow portion
95: holding portion
96: conductive portion
97, 98: terminal

### BEST MODES FOR CARRYING OUT THE INVENTION

The embodiments of the present invention will now be described while referring to drawings.

### Embodiment 1

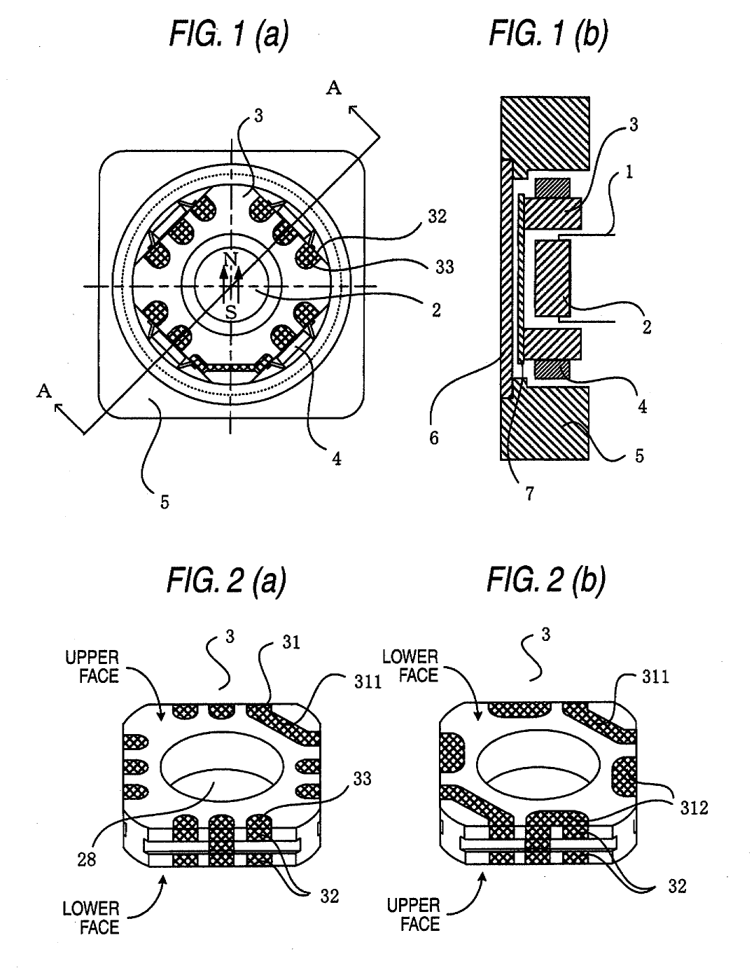

In FIG. 1, FIG. 1(a) is a front view of a magnetic encoder apparatus according to a first embodiment of the present invention, and FIG. 1(b) is a cross-sectional view taken along line A-A in FIG. 1(a).

In the drawing, reference numeral 2 denotes a permanent magnet, fixed to a rotary member 1, and arrows shown on the permanent magnet 2 indicate magnetization directions. Reference numeral 3 denotes a fixed member, formed of an insulating material, and in this embodiment, a glass epoxy substrate is employed. Reference numeral 4 denotes four magnetic field detection elements, which are secured to the fixed member 3, opposite the permanent magnet 2, with an intervening gap; reference numeral 5 denotes a frame used for securing the fixed member 3; reference numeral 6 denotes a cover attached to the frame 5; and reference numeral 7 denotes a flexible printed circuit on which a wiring pattern is formed for connecting the magnetic field detection elements 4 to a signal processing circuit (not shown).

The signal processing circuit (not shown), arranged externally, receives signals from the magnetic field detection elements 4, converts them into position data, and transmits the position data to an upper controller. It should be noted that the cover 6 and the flexible printed circuit 7 are not shown in FIG. 1(a).

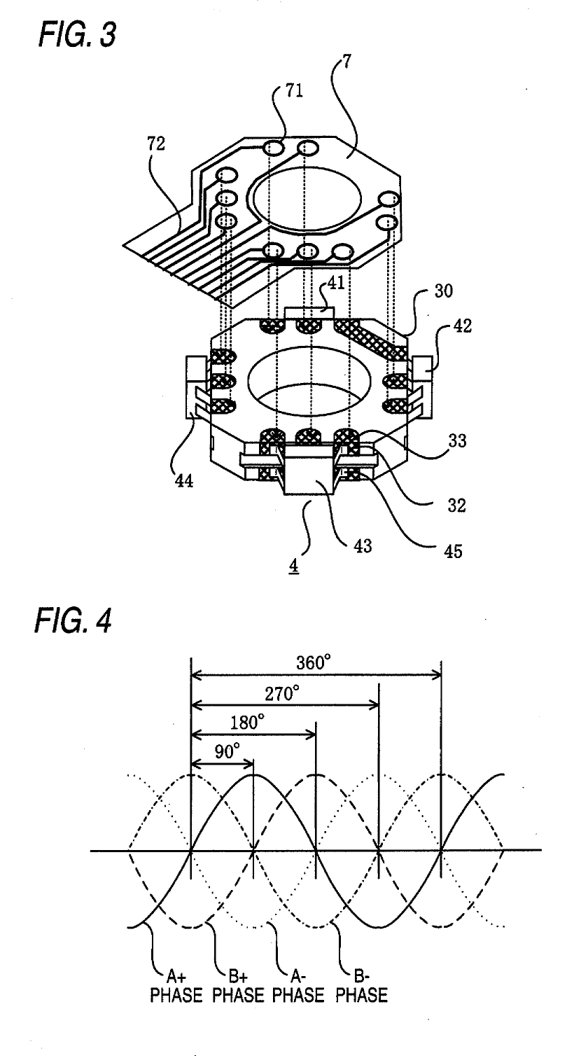

FIG. 2 is a perspective view of the structure of the fixed member according to this embodiment, i.e., FIG. 2(a) is a perspective view with a top faced upward, and FIG. 2(b) is a perspective view with a bottom faced upward. Further, FIG. 3 is a perspective view of the state wherein the fixed member, the magnetic field detection elements and the flexible printed circuits are connected.

As shown in FIG. 2, the fixed member 3 is almost a right square prism, wherein a cylindrical space 28 is formed in the center. The corners have small, arced shapes and internally touch the frame 5, through the hole, when the fixed member 3 is secured. Reference numeral 311 denotes a power supply pattern for supplying electric power to the magnetic field detection elements, and reference numeral 312 denotes a signal pattern connected to the output terminals of the magnetic field detection elements. Furthermore, reference numeral 32 denotes a plurality of pads formed on the side faces of the fixed member 3, and reference numeral 33 denotes a plurality of pads formed on the upper face of the fixed member. Some of the plurality of pads 32 formed on the side faces are connected to the pads 33 on the upper face, via the signal pattern 312.

As shown in FIG. 3, the four magnetic field detection elements 4, which are an A+ phase magnetic field detection element 41, a B+ phase magnetic field detection element 42, an A− phase magnetic field detection element 43 and a B− phase magnetic field detection element 44, are mounted on the pads 32, and are electrically connected to leads 45 for the magnetic field detection elements 4. In addition, the pads 33 are respectively connected to terminals 71 of the flexible printed circuit 7, and are connected to the signal processing circuit (not shown) by a wiring pattern 72.

FIG. 4 is an output signal waveform diagram for the magnetic field detection elements 4, and as shown in this diagram, a pseudo-sinusoidal signal is output. In the diagram, an A+ phase, a B+ phase, an A− phase and a B− phase are signals respectively output by the A+ phase magnetic field detection element 41, the B+ phase magnetic field detection element 42, the A− phase magnetic field detection element 43 and the B− phase magnetic field detection element 44. When the magnetic field detection elements 4 are attached at the individual ideal positions of 90°, pseudo-sinusoidal signals with the ideal phase differences can be obtained, i.e., a phase difference of 90° for the B+ phase relative to the A+ phase, a phase difference of 180° for the A− phase, and a phase difference of 270° for the B− phase. However, in a case wherein the magnetic field detection elements 4 are mounted with an error, the mounting error appears as a phase difference error between pseudo-sinusoidal signals. Actually, for a case involving a conventional magnetic encoder apparatus, a maximum of about 11° appears as the phase difference error. When this value is converted into a mounting error, this corresponds to about 0.5 mm.

In this embodiment, the pads 32 can be prepared on the substrate with a tolerance of about 0.1 mm or less, and in a case wherein a distance of 5 mm, used for the conventional art, is also employed as a distance from the center point of the permanent magnet 2 to the magnetic field detection elements 4, a phase error of about 1.1° is obtained. As described above, since the positioning accuracy for pads is improved, the positioning accuracy for the magnetic field detection elements is increased. It is found that, compared with the conventional art, the angle precision is improved about 10 times.

As another characteristic, since the fixed member includes a power supply pattern for connecting the power sources for the four magnetic field detection elements, the number of external wires can be reduced, and since a signal pattern is formed so that a connection to the flexible printed circuit can be established only using the upper face, the structure of a magnetic encoder apparatus is simplified.

### Embodiment 2

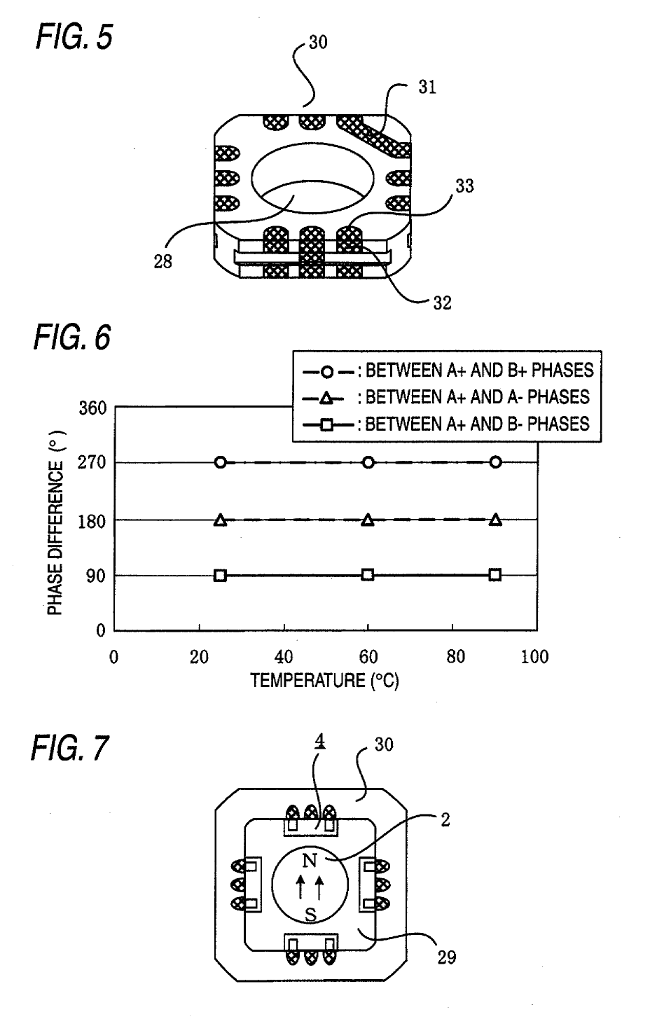

FIG. 5 is a perspective view of a fixed member according to this embodiment.

In this diagram, reference numeral 30 denotes a fixed member produced using ceramics. A difference in this embodiment, from the first embodiment, is that a ceramic is employed as the material for a fixed member.

The thermal expansion coefficient of ceramics is low, and is about 20 to 40% for a glass epoxy substrate (FR-4) or about 4 to 8% for a flexible printed circuit (polyimide). With an arrangement wherein magnetic field detection elements 4 are mounted on pads 32 of the ceramic fixed member 30, the resulting affect is small, such as thermal expansion, due to temperature change, and the angle of the mounting position is substantially unchanged by temperature. Therefore, almost no phase difference errors, due to temperature changes, appear between pseudo-sinusoidal signals output by the magnetic field detection elements. The results obtained by measuring the effect of temperatures on phase differences for a pseudo-sinusoidal wave are shown in FIG. 6. Also apparent from the results, there are no phase difference errors.

### Embodiment 3

FIG. 7 is a front view of a fixed member according to a third embodiment of the present invention.

In this diagram, reference numeral 29 denotes a space having almost a square shape. In this embodiment, pads are formed on the side faces at the space 29, and magnetic field detection elements 4 are fixed to the pads.

A difference in this embodiment from the second embodiment is that in the second embodiment, magnetic field detection elements are arranged on the external side walls of the fixed member, while in this embodiment, magnetic field detection elements are arranged on the side faces, along the space that is formed in the fixed member.

As descried above for this embodiment, the magnetic field detection elements are arranged on the side faces, along the space that is formed in the fixed member, and a gap can be reduced between the permanent magnet and the magnetic field detection elements. Therefore, magnitude levels of signals detected by the magnetic field detection elements can be increased, and a noise-resistant magnetic encoder apparatus can be provided.

### Embodiment 4

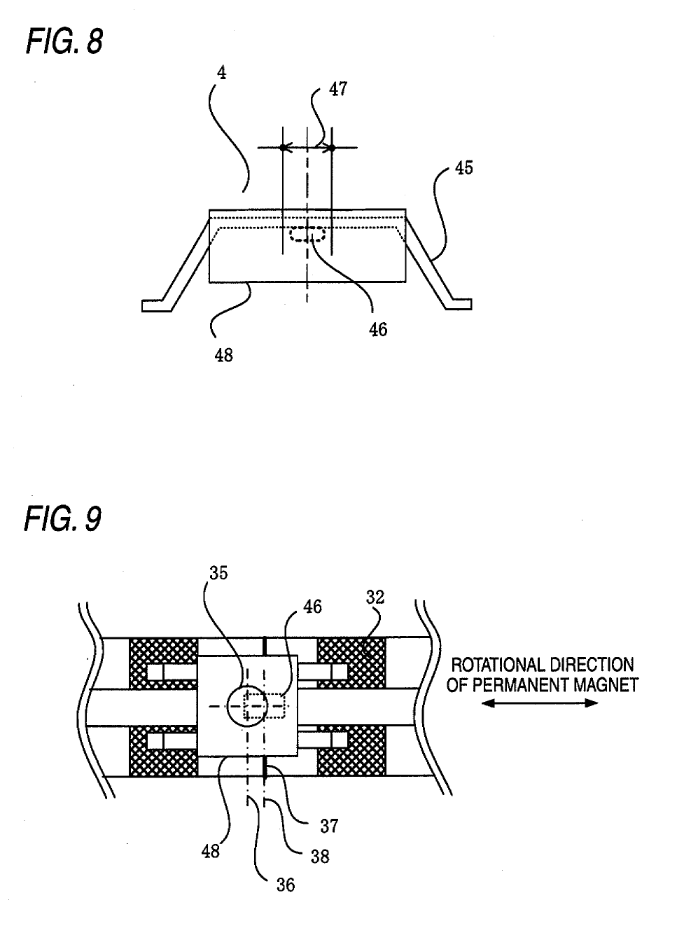

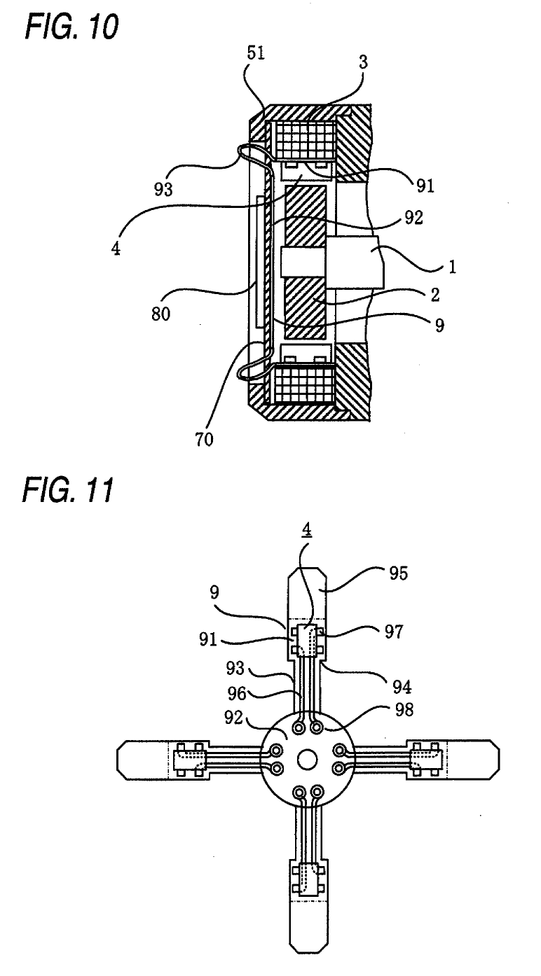

FIG. 8 is a diagram illustrating the position of a chip for a magnetic field detection element according to a fourth embodiment of the present invention. A Hall effect sensor that incorporates a Hall element is employed as each magnetic field detection element.

In the drawing, reference numeral 46 denotes a magnetic field detection element chip (Hall element chip), and reference numeral 45 denotes a magnetic field detection element lead that mounts the chip 46 and connects a chip terminal (not shown) using wire bonding.

There is a variance in the positions of the magnetic field detection chips 46, and accordingly, a phase error occurs in detection signals. In order to reduce the error, simply the positions of the chips inside the all effect sensors are measured using X-ray irradiation, and are aligned with the center positions, on the side faces of the fixed member 3, in a rotational direction relative to the permanent magnet.

Next, the method for positioning the Hall effect sensor according to this embodiment will be described.

FIG. 9 is a partial side view of the fixed member, showing the position of a magnetic field detection element on the side face of the fixed member.

In the drawing, reference numeral 35 denotes the sensor center for a Hall effect sensor package 48, which is provided as a circular, recessed portion. Reference numeral 36 denotes the centerline of the sensor center. Reference numeral 37 denotes a notch line 37 that is formed in the side face of the fixed member, indicating the center position of a fixed member.

The position of the magnetic field detection element chip in the package 48 is measured in advance using X-ray irradiation, and an error, relative to the sensor center 35, is calculated. Taking the error into account, the position of the sensor center is adjusted along the notch line 37, and secured to the fixed member. The Hall effect sensor, where the sensor center 35 is not formed, can be positioned using the location of the end face of the package 48.

As described above, according to this embodiment, inexpensive Hall effect sensors are employed for the magnetic field detection elements, and are secured to the fixed member by taking into account the positioning error for the chips relative to the packages. Therefore, the phase error, for detection signals, that occurs due to the chip positioning error can be reduced, and a magnetic encoder apparatus having high detection accuracy can be provided at a low price.

Furthermore, when a reference chip position range 47 is determined for the positions of the chips inside the Hall effect sensors, and when the Hall effect sensors that fall within the reference range are selected, by measuring the chip positions of the magnetic field detection elements using X-ray irradiation, and are attached to the pads 32 of the fixed member 3, a very accurate magnetic encoder apparatus can be easily produced.

In the description of this embodiment, only a disk-shaped permanent magnet is employed; however, it is obvious that the same effects can be obtained using a ring-shaped permanent magnet.

### INDUSTRIAL APPLICABILITY

The present invention can be applied for a small magnetic encoder apparatus that detects the rotational position or rotational speed of a servomotor.

1. A magnetic encoder apparatus comprising:
a disk-shaped or ring-shaped permanent magnet that is fixed to a rotary member and is magnetized in a direction perpendicular to an axis of the rotary member;
a fixed member in which a space is formed to arrange the permanent magnet;
a plurality of magnetic field detection elements that are radially arranged opposite the permanent magnet with an intervening gap;
a signal processing circuit that processes signals obtained by the magnetic field detection elements; and
conductive pads for electrical connections to the magnetic field detection elements, being mounted on a side face of an electrical insulating material substrate of the fixed member.

2. The magnetic encoder apparatus according to claim 1, wherein
the fixed member is formed of ceramics.

3. The magnetic encoder apparatus according to claim 1, wherein
either a power supply pattern for supplying electric power to the magnetic field detection elements, or the power supply pattern and a signal pattern for connections to output terminals of the magnetic field detection elements, are formed for the fixed member.

4. The magnetic encoder apparatus according to claim 1, wherein
the fixed member is almost a right square prism in which a cylindrical space is internally formed.

5. The magnetic encoder apparatus according to claim 1, wherein
the fixed member includes a space having an almost square shape.

6. The magnetic encoder apparatus according to claim 1, wherein
positioning portions for fixing the magnetic field detection elements are formed on side faces of the fixed member.

7. The magnetic encoder apparatus according to claim 6, wherein
the positioning portions serve as a reference centerline for positioning the magnetic field detection elements.

8. The magnetic encoder apparatus according to claim 1, wherein
the magnetic field detection elements are Hall effect sensors including Hall elements in packages.

9. A method for manufacturing a magnetic encoder apparatus comprising: a disk-shaped or ring-shaped permanent magnet that is fixed to a rotary member and is magnetized in a direction perpendicular to an axis of the rotary member; a fixed member in which a space is formed to arrange the permanent magnet; four magnetic field detection elements that are radially arranged opposite the permanent magnet with an intervening gap; and a signal processing circuit that processes signals obtained by the magnetic field detection elements,
the method comprising:
securely attaching the magnetic field detection elements to the fixed member so that chips in packages of the magnetic field detection elements are positioned at 90 degree angles of each other.

10. The magnetic encoder apparatus manufacturing method according to claim 9, wherein
a centerline for a positioning reference is formed on side faces of the fixed member;
positioning for the chips in the packages is calculated;
positions for mounting the packages on the fixed member are adjusted to align the positions of the chips with the centerline; and
the packages are fixed to the fixed member.
